(19) United States
(12) Patent Application Publication
(10) Pub. No.: US 2025/0389604 A1
(43) Pub. Date: Dec. 25, 2025

(54) EXTENDED RANGE SILICON PRESSURE SENSOR WITH IMPROVED OVERPRESSURE RESPONSE

(71) Applicant: Rosemount Inc., Shakopee, MN (US)

(72) Inventors: Nicholas E. MEYER, Victoria, MN (US); David M. STREI, Waconia, MN (US)

(21) Appl. No.: 18/751,809

(22) Filed: Jun. 24, 2024

(51) Int. Cl. G01L 19/06; G01L 9/00; G01L 19/08

(52) U.S. Cl. CPC G01L 19/0618; G01L 19/086; G01L 9/0051; G01L 9/0072

(57) ABSTRACT

A pressure sensor includes a first silicon die having a deflectable diaphragm and a second silicon die contacting the first silicon die at an interface. An electrical structure is mounted relative to one of the first and second silicon dies. The electrical structure has an electrical characteristic that changes based on deflection of the deflectable diaphragm. An overpressure feature is mounted relative to one of the first silicon die and the second silicon die. The overpressure feature has a surface that is configured to contact the other of the first silicon die and second silicon die during an overpressure condition. At least one frit region has a frit gap. Glass frit is disposed in the frit gap. A pressure transmitter having the above-described pressure sensor is also disclosed.

### BACKGROUND

In some process control system installations, a pressure transmitter is used to monitor the pressure of a process fluid in a conduit or storage tank. The pressure transmitter includes circuitry that measures or otherwise obtains an electrical indication of a pressure sensor that is hydraulically coupled to the remote location of the pressure being monitored. The magnitude of the pressure sensor signal represents the pressure of the process fluid.

In many pressure sensors, a flexible diaphragm moves relative to a base in response to pressure applied to the top of the diaphragm. The diaphragm typically includes one or more electrical structures, such as electrodes or traces, that have an electrical characteristic, such as resistance or capacitance, that changes with the deflection of the sensing diaphragm. Diaphragms that provide repeatable monotonic movement in response to applied pressures are preferred. As a result, crystalline diaphragms, such as those made from crystalline silicon have been widely adopted since they provide monotonic movement in response to applied pressures and are generally free of hysteretic effects. Unfortunately, sensors with such crystalline structures have limited over-pressure capability and excessive pressure on the sensor diaphragm can cause large tensile stresses that exceed the crystalline structure's maximum fracture strength. Failures in such sensors tend to be catastrophic often resulting in an entirely shattered structure.

### SUMMARY

A pressure sensor includes a first silicon die having a deflectable diaphragm and a second silicon die contacting the first silicon die at an interface. An electrical structure is mounted relative to one of the first and second silicon dies. The electrical structure has an electrical characteristic that changes based on deflection of the deflectable diaphragm. An overpressure feature is mounted relative to one of the first silicon die and the second silicon die. The overpressure feature has a surface that is configured to contact the other of the first silicon die and second silicon die during an overpressure condition. At least one frit region has a frit gap. Glass frit is disposed in the frit gap. A pressure transmitter having the above-described pressure sensor is also disclosed.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a diagrammatic view of a pressure sensing system in accordance with an embodiment of the present invention.

FIG. 2 is an enlarged view of a portion of a pressure sensor in accordance with an embodiment of the present invention.

FIG. 3 is a block diagram of a pressure sensing system with which embodiments described herein are particularly useful.

FIG. 4 is a diagrammatic view of a pressure sensing system with which embodiments described herein are particularly useful.

### DETAILED DESCRIPTION OF ILLUSTRATIVE EMBODIMENTS

Some existing semiconductor-based pressure sensors employ etched overpressure stop features that are integrated with the sensing diaphragm. To be most effective at increasing the overpressure capability, the etched overpressure features should contact the backing wafer soon after the upper measurement range limit (URL) of the sensor. This is because the stress in the sensing diaphragm rapidly increases until the overpressure stop engages.

Designing an extended range silicon pressure sensor requires a sensing diaphragm that deflects through all of the operating range of the pressure sensor. However, as set forth above, it is important for any overpressure features to engage relatively quickly after the pressure exceeds the URL of the pressure sensor. For silicon structures that are able to accommodate such design constraints, the precision of the gaps required for creating effective overpressure stops are challenging for modern pressure sensor manufacturing techniques. For example, known semiconductor pressure sensors are sometimes built as two sensor halves that are then bonded together with a known glass frit bonding technique. However, the distance between the final two halves is often a function of the amount of glass frit used for the bond, the pressure applied during the glass frit bonding process, the temperature applied during the glass frit bonding process, and the time allowed for the bonding process. As a result, modern techniques have been limited with respect to the exacting tolerances required of overpressure features for silicon pressure sensors.

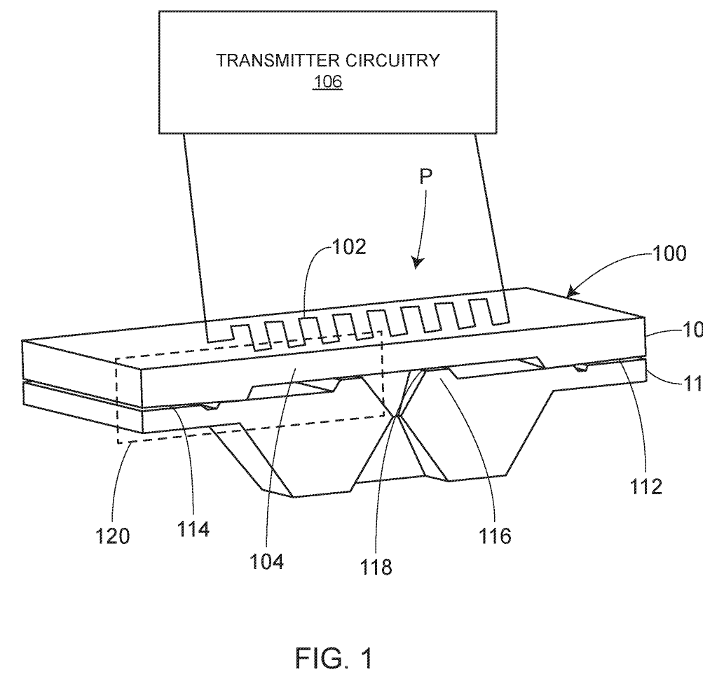

FIG. 1 is a diagrammatic view of a pressure sensing system in accordance with an embodiment of the present invention. Pressure sensor 100 includes an electrical structure 102 that has an electrical characteristic, such as resistance or capacitance, that changes with deflection of a deflectable diaphragm 104. In the illustrated example, electrical structure 102 is shown as a resistive strain gauge element coupled to transmitter circuitry 106, which is configured to measure the resistance of the resistive strain gauge element to determine deflection of deflectable diaphragm 104 and provide a process pressure output.

Pressure sensor 100 is formed by bonding, fusing, or otherwise coupling silicon device wafer 108 to silicon backing wafer 110. In one example, a glass frit (generally a low-melting point glass) is provided in regions 112, 114 between device wafer 108 and backing wafer 110. Regions 112, 114 are depicted separately, but are generally one continuous feature on backing wafer 110. The glass, when heated to a suitable temperature (typically between 450 deg C to 550 deg C) will flow and wet the opposing surfaces of device wafer 108 and backing wafer 110 well below the temperature where deformation or degradation of either of the device wafer 108 or backing wafer 110.

As shown in FIG. 1, pressure sensor 100 includes an overpressure pedestal 116 that is spaced slightly apart from deflectable diaphragm 104. As process fluid pressure P is applied to deflectable diaphragm 104, diaphragm 104 will deflect downwardly, or in the direction of the applied process fluid pressure. This deflection is measurable by electrical structure 104 through an operating pressure range of pressure sensor 100. However, the gap 118 between overpressure pedestal 116 and deflectable diaphragm 104 is designed such that at a certain degree after the designed upper measurement limit, such as 10% above the upper measurement limit, the surface of deflectable diaphragm 104 will contact the surface of overpressure pedestal 116, which will then prevent additional deflection of deflectable diaphragm 104.

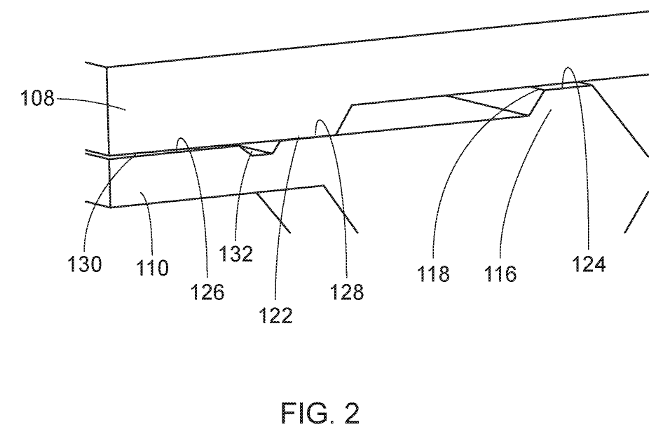

FIG. 2 is an enlarged view of a portion of a pressure sensor in accordance with an embodiment of the present invention. FIG. 2 is an enlarged view of region 120 shown in FIG. 1. As can be seen in FIG. 2, device wafer 108 and backing wafer 110 contact one another at interface 122. Additionally, surfaces 124 and 126 on silicon backing wafer 110 are etched or otherwise machined to be precisely offset from surface 128, which contacts silicon device wafer 108. Etching is preferably used to generate these precise offsets since etching can provide very precise tolerances. For example, in one embodiment, the tolerance of surface 124 relative to surface 128 is +/- 1 micron. Etching also allows the thickness of the deflectable diaphragm 104 to be precisely controlled. In one embodiment, the thickness of the etched diaphragm depth is +/- 1.5 micron. Accordingly, the gap 118 between overpressure pedestal 116 and deflectable diaphragm 104 can be precisely controlled. This precision manufacturing allows for a pressure sensor that can sense a larger range of pressures, but still has an overpressure protection that engages very quickly and precisely after a selected threshold above the maximum measurement range.

As shown in FIG. 2, surface 126 is spaced apart from device wafer 108 to create a glass frit gap 130. During manufacture, glass frit is deposited onto one or both of device wafer 108 and backing wafer 110 in the region of gap 130. Then, device wafer 108 and backing wafer 110 are pressed together during the high temperature glass frit bonding process until there is contact between device wafer 108 and backing wafer 110 at interface 128. Excess glass frit may flow into channel 132. Regardless, the final, manufactured, distance between device wafer 108 and backing wafer 110 is set by interface 128, and not by the thickness of glass frit in gap 130. By causing contact at interface 128 during the manufacture of pressure sensor 100, +/- 2 microns of frit thickness variation is eliminated. This significantly increases the precision of the engagement of overpressure protection.

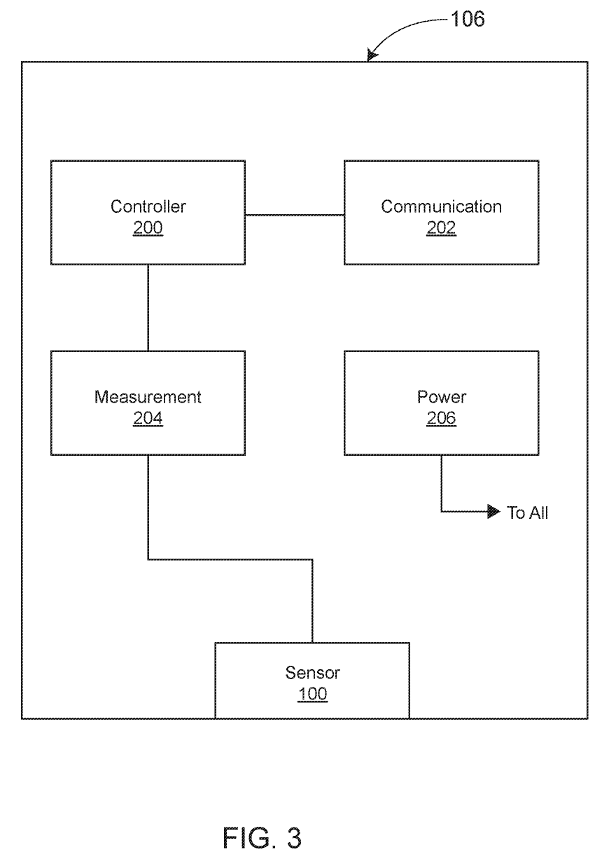

FIG. 3 is a block diagram of a pressure sensing system with which embodiments described herein are particularly useful. Transmitter electronics 106 includes controller 200, communication module 202, measurement circuitry 204 and power module 206. As shown in FIG. 3, measurement circuitry 204 is coupled to pressure sensor 100.

Controller 200 may be any suitable circuitry that is able to execute a number of programmatic steps or functions to communicate with an external device using communication module 202. Controller 200 may be an application specific integrated circuit (ASIC), field programmable gate array (FPGA), microcontroller, or microprocessor.

Communication module 202 is configured to interact with controller 200 and to communicate in accordance with one or more standard protocols. The standard protocol may be a wired communication protocol, such as HART, 4-20mA, FOUNDATION^{™} Fieldbus, Profibus, Modbus, Ethernet, and Ethernet-APL. The standard protocol may be a wireless communication protocol. Examples of wireless communication protocols include, without limitation, WirelessHART, Cellular (NB-IoT, LTE-M), Wi-Fi, LoRaWAN, and Bluetooth Low Energy.

Electronics module 106 includes power management circuitry 206 and provides regulated power to components of transmitter electronics 106. Additionally, power management circuitry 206 can also provide voltage monitoring for battery-operated assemblies.

As shown in FIG. 3, transmitter electronics 106 includes measurement circuitry 204 coupled to controller 200. Measurement circuitry 204 includes suitable circuitry for measuring an analog electrical characteristic (e.g., resistance, voltage, current, et cetera) and providing a digital indication of the measured analog electrical characteristic to controller 200. Suitable examples of circuitry of measurement processing circuitry includes one or more analog-to-digital converters, one or more amplifiers, and or one or more multiplexers or switches. Measurement circuitry 204 is coupled to pressure sensor 100 and is able to measure the electrical characteristic (e.g., resistance, capacitance, et cetera) of pressure sensor 100 and provide a digital indication thereof to controller 200.

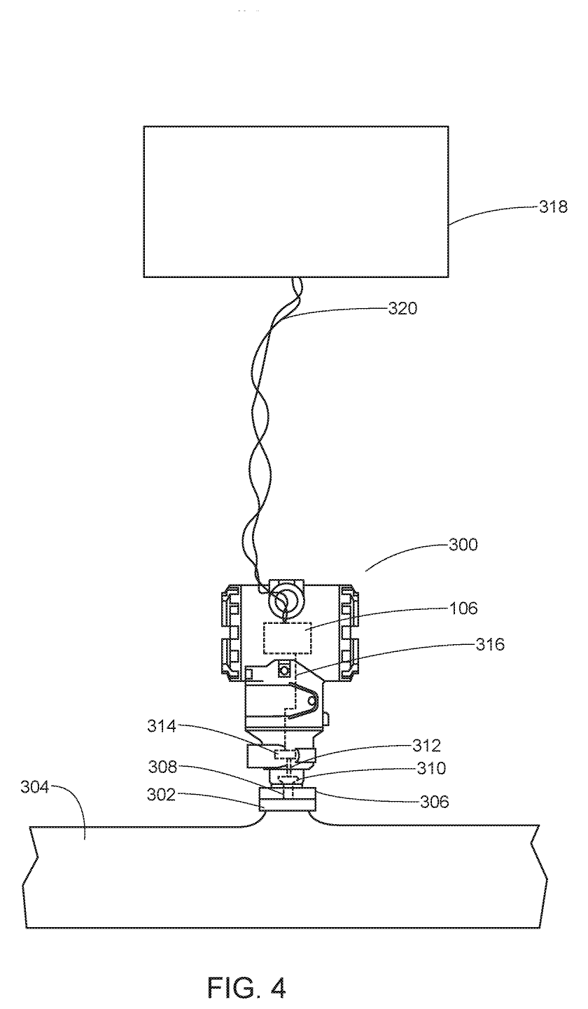

FIG. 4 is a diagrammatic view of a pressure sensing system with which embodiments described herein are particularly useful. FIG. 4 is a perspective view of a portion of a process control system in which the pressure sensors described above are used in accordance with some embodiments. In FIG. 4, a process variable transmitter 300 is mounted to a process coupling 302 of a pipe section 304 by a mounting member 306.

Mounting member 306 includes bore 308 which extends from process coupling 302 to an isolation diaphragm assembly 310. Isolation diaphragm assembly 310 includes an isolation diaphragm that isolates the process fluid in pipe section 304 from isolation fluid carried in an isolation capillary 312. Isolation capillary 312 couples to a pressure sensor 314, which takes the form of pressure sensor 100 described above. Sensor 314 is configured to measure an absolute pressure (relative to vacuum) or a gage pressure (relative to atmospheric pressure) and provide an electrical output 316 to transmitter circuitry 106.

Transmitter circuitry 106 communicates with control room 318 to provide one or more process variables to control room 318, such as absolute pressure and gage pressure. Transmitter circuitry 106 may communicate with control room 318 using various techniques including both wired and wireless communication. One common wired communication technique uses what is known as a two-wire process control loop 320 in which a single pair of wires is used to carry information as well as provide power to transmitter 300. One technique for transmitting information is by controlling the current level through process control loop 320 between 4 milliamps and 20 milliamps. The value of the current within the 4-20 milliamp range can be mapped to corresponding values of the process variable.

Although the present invention has been described with reference to preferred embodiments, workers skilled in the art will recognize that changes may be made in form and detail without departing from the spirit and scope of the invention.

1. A pressure sensor comprising:
a first silicon die having a deflectable diaphragm;
a second silicon die contacting the first silicon die at an interface;
an electrical structure mounted relative to one of the first and second silicon dies, the electrical structure having an electrical characteristic that changes based on deflection of the deflectable diaphragm;
an overpressure feature mounted relative to one of the first silicon die and the second silicon die, the overpressure feature having a surface that is configured to contact the other of the first silicon die and second silicon die during an overpressure condition;
at least one frit region having a frit gap; and
glass frit disposed in the frit gap.

2. The pressure sensor of claim 1, wherein the overpressure feature is mounted to the second silicon die.

3. The pressure sensor of claim 1, wherein the overpressure feature is a pedestal.

4. The pressure sensor of claim 3, wherein the pedestal is located centrally relative to the deflectable diaphragm.

5. The pressure sensor of claim 1, wherein the electrical characteristic is resistance.

6. The pressure sensor of claim 1, wherein the electrical characteristic is capacitance.

7. The pressure sensor of claim 1, wherein the overpressure feature extends from a plane of the interface between the first and second silicon dies, to the surface of the overpressure feature.

8. The pressure sensor of claim 7, wherein a distance from the plane to the surface is controlled by an etching process.

9. The pressure sensor of claim 7, wherein a distance from the plane to the surface has a tolerance of +/- 1 micron.

10. The pressure sensor of claim 1, wherein the deflectable diaphragm is formed in the first silicon die by an etching process.

11. The pressure sensor of claim 10, wherein a tolerance of a depth of the etched diaphragm is +/- 1.5 microns.

12. The pressure sensor of claim 1, and further comprising a channel disposed proximate the frit gap such that excess frit in the frit gap may flow into the channel.

13. The pressure sensor of claim 1, wherein the interface is configured to set a distance between the surface of the overpressure feature and the other of the first silicon die and second silicon die.

14. The pressure sensor of claim 1, wherein the interface is configured to determine a size of the frit gap.

15. A pressure transmitter comprising:
transmitter circuitry configured to measure an electrical characteristic of a pressure sensor and provide a process fluid pressure output; and
a pressure sensor including,
a first silicon die having a deflectable diaphragm;
a second silicon die contacting the first silicon die at an interface;
an electrical structure coupled to the transmitter circuitry and mounted relative to one of the first and second silicon dies, the electrical structure having an electrical characteristic that changes based on deflection of the deflectable diaphragm;
an overpressure feature mounted relative to one of the first silicon die and the second silicon die, the overpressure feature having a surface that is configured to contact the other of the first silicon die and second silicon die during an overpressure condition;
at least one frit region having a frit gap; and
glass frit disposed in the frit gap.

16. The pressure transmitter of claim 15, wherein the transmitter circuitry includes measurement circuitry coupled to the pressure sensor, the measurement circuitry being configured to measure the electrical characteristic of the electrical structure.

17. The pressure transmitter of claim 16, wherein the measurement circuitry is configured to measure a resistance of the electrical structure.

18. The pressure transmitter of claim 16, wherein the measurement circuitry is configured to measure a capacitance of the electrical structure.

19. The pressure transmitter of claim 15, wherein the pressure sensor includes a channel disposed proximate the frit gap such that excess frit in the frit gap may flow into the channel.

20. The pressure transmitter of claim 15, wherein the interface is configured to set a distance between the surface of the overpressure feature and the other of the first silicon die and second silicon die.

21. The pressure transmitter of claim 15, wherein the interface is configured to determine a size of the frit gap.
